(19) United States
(12) Patent Application Publication
(10) Pub. No.: US 2024/0070493 A1
(43) Pub. Date: Feb. 29, 2024

(54) INFORMATION PROCESSING APPARATUS, INFORMATION PROCESSING SYSTEM, INFORMATION PROCESSING METHOD, AND NON-TRANSITORY COMPUTER-READABLE MEDIUM STORING PROGRAM

(71) Applicant: NEC Corporation, Tokyo (JP)

(72) Inventor: Toru Aoyagi, Tokyo (JP)

(73) Assignee: NEC Corporation, Tokyo (JP)

(21) Appl. No.: 18/230,471

(22) Filed: Aug. 4, 2023

(30) Foreign Application Priority Data
Aug. 25, 2022 (JP) 2022-134246

(51) Int. Cl. G06N 5/04

(52) U.S. Cl. CPC G06N 5/04

(57) ABSTRACT

An information processing apparatus includes: a storage unit configured to store a question associated with a consumption behavior of a user; and at least one processor. The at least one processor presents a question associated with a consumption behavior of a user being stored in the storage unit, acquires an answer to the presented question, estimates a psychological attribute of the user based on the answer, requests the user to make a choice as to whether to permit the use of personal information, along with presenting a result of the estimation, presents choices as to whether to permit the use of personal information, along with presenting the result of the estimation, and accepts a result of the choice.

### INCORPORATION BY REFERENCE

This application is based upon and claims the benefit of priority from Japanese patent application No. 2022-134246, filed on Aug. 25, 2022, the disclosure of which is incorporated herein in its entirety by reference.

### TECHNICAL FIELD

The present disclosure relates to an information processing apparatus, an information processing system, an information processing method, and a program.

### BACKGROUND ART

Business operators that provide products or services acquire information associated with users (personal information), such as user profiles and preferences, and use this information for conducting advertising activities. User attribute information includes demographic attributes and psychographic attributes. Various proposals have been made to use such personal information for conducting effective advertising activities or businesses.

For example, a system described in Japanese Unexamined Patent Application Publication No. 2015-187764 matches relevant health information with regard to health information being classified as permission for use, extracts the matched relevant health information, and provides information that prompts permission for use along with the extracted relevant health information.

A system described in Japanese Patent No. 6940904 recognize, based on preference information recognized from answers to a questionnaire and marketing information, secondary candidates from primary candidates included in a population selected from population candidates, and inquires of the secondary candidates whether to use an individual identifier.

A business operator utilizes browsing information of a user (for example, HTTP cookies and the like) in order to issue an effective targeted advertisement, for example, by using the above-described techniques. On the other hand, use of third-party cookies has been restricted based on a viewpoint of privacy protection, and a procedure of acquiring permission (opt-in) from a user for use of personal information and the like has been under stricter control these days. As a result, it is difficult to issue targeted advertisements to a large number of users. Furthermore, unless opt-in is acquired, a targeted advertisement cannot be issued.

### SUMMARY

In view of the above-described problem, an example object of the present disclosure is to provide an information processing apparatus and the like that effectively acquire opt-in while appropriately protecting privacy of a user.

An information processing apparatus according to the present disclosure includes a storage unit, a question processing unit, an estimation unit, a selection request unit, and a reception unit. The storage unit stores a question associated with a consumption behavior of a user. The question processing unit presents the question and acquires an answer to the presented question. The estimation unit estimates a psychological attribute of the user, based on the answer. The selection request unit requests the user to make a choice as to whether to permit use of personal information, along with presenting a result of the estimation. The reception unit accepts a result of the choice.

An information processing method according to the present disclosure causes a computer to perform the following method. The computer stores a question associated with a consumption behavior of a user. The computer presents the question and acquires an answer to the presented question. The computer estimates a user attribute, based on the answer to the question. The computer requests the user to make a choice as to whether to permit use of personal information, along with presenting a result of the estimation. The computer accepts the choice.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram of an information processing apparatus according to a first example embodiment;

FIG. 2 is a flowchart of the information processing method according to the first example embodiment;

FIG. 3 is a schematic configuration diagram of an information processing system according to a second example embodiment;

FIG. 4 is a block diagram of an information processing apparatus according to the second example embodiment;

FIG. 5 is a block diagram of an information management apparatus according to the second example embodiment;

FIG. 6 is a block diagram of a service provision apparatus according to the second example embodiment;

FIG. 7 is a flowchart of an information processing method according to the second example embodiment;

FIG. 8 is a diagram illustrating an example of a question presented on the information processing apparatus:

FIG. 9 is a diagram illustrating an example of a result of estimation presented on the information processing apparatus;

FIG. 10 is a diagram illustrating an example of choices presented on the information processing apparatus; and

FIG. 11 is a block diagram exemplifying a hardware configuration of a computer.

### EXAMPLE EMBODIMENT

The following describes the present disclosure by means of example embodiments without limiting the disclosure according to the claims to the following example embodiments. Furthermore, not all of the components described in the example embodiments are necessary as means for solving the problem. For clarity of description, the following description and drawings are abbreviated and simplified as appropriate. Note that, in the drawings, the same elements are given the same signs, and duplicate descriptions are omitted if necessary.

### First Example Embodiment

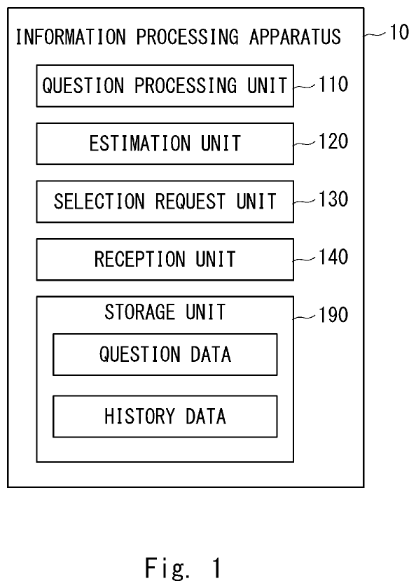

The following describes a first example embodiment with reference to the drawings. FIG. 1 is a block diagram of an information processing apparatus 10 according to the first example embodiment. The information processing apparatus 10 is, for example, a terminal such as a smartphone, a tablet terminal, a personal computer, or the like used by a user. The information processing apparatus 10 includes, as main components, a question processing unit 110, an estimation unit 120, a selection request unit 130, a reception unit 140, and a storage unit 190.

The question processing unit 110 presents a predetermined question to a user and acquires an answer to the presented question. The question processing unit 110 presents a question for estimating a psychological attribute (also referred to as a psychographic attribute) of a user. The question presented by the question processing unit 110 is stored in the storage unit 190. The psychological attribute is data on the psychological characteristics with regard to a user's life and values. The psychological attribute is, for example, reflections of the user's lifestyle, hobbies, preferences, values, and/or the like. More specifically, the psychological attribute may include, for example, a genre of music, a movie, or other copyrighted works that the user likes. Alternatively, the psychological attribute may include information indicative of the user's tendency in activities, hobbies, and/or favorite foods and beverages. Note that the psychological attribute of a user is information associated with an individual user, and may be included in personal information.

The estimation unit 120 estimates the psychological attribute of the user using the answer acquired by the question processing unit 110. For example, when a user selects one film from among films of a plurality of different genres, a music genre that the user is presumed to be interested in is estimated based on the selection of that film genre. In this case, the estimated music genre may be a plurality of music genres or may be a plurality of music genres with scores assigned. The estimation unit 120 has a predetermined algorithm for making the above-described estimation. The estimation unit 120 may be an inference device that is trained by machine learning.

The selection request unit 130 presents the result of the estimation calculated by the estimation unit 120. The result of the estimation includes a psychological attribute estimated by the estimation unit 120, of which presentation mode is not limited. However, the presentation mode of the result of the estimation is preferably a content that the user can sympathize with. Alternatively, the presentation mode of the result of the estimation is preferably a content for which a user wants further information. Such a mode facilitates the information processing apparatus 10 to prompt the user to permit the use of personal information.

The selection request unit 130 requests the user to make a choice as to whether to permit the use of personal information, along with presenting the above-mentioned result of the estimation. The choices regarding whether to permit the use of personal information are, for example, a choice to “permit” and a choice to “not permit”.

The reception unit 140 accepts the result selected by the user. That is, the reception unit 140 may include an interface that accepts a user operation. When the reception unit 140 accepts the result selected by the user, the result of the accepted selection can be used for other functions of the information processing apparatus 10. Other functions include, for example, an advertisement to be presented to the user.

By presenting choices as to whether to permit the use of personal information, along with presenting the result of the estimation, the information processing apparatus 10 can proclaim an intention to use the personal information to the user in an understandable manner. In this way, the information processing apparatus 10 can preferably prompt a user to permit the use of personal information. In addition, the information processing apparatus 10 can appropriately protect the privacy of a user who has not permitted the use of personal information.

The storage unit 190 is a storage device including a non-volatile memory. The storage unit 190 stores question data and historical data. The question data are a collection of a plurality of questions to be presented by the question processing unit 110. A question to a user is related to the consumption behavior of the user. A question to a user is also related to the psychological attribute of the user. That is, when a user answers a plurality of questions, the information processing apparatus 10 can estimate psychological attributes related to the consumption behavior of the user from the answers.

The historical data stored in the storage unit 190 include the content of the presented question and the answer to the question. The historical data also include information regarding a psychological attribute estimated from the acquired answer. Further, the historical data include the result of the choice.

The configuration of the information processing apparatus 10 has been described thus far. Based on the above configuration, the information processing apparatus 10 estimates a psychological attribute of a user using a predetermined question and presents a result of the estimation. The result of the estimation includes information that is likely to interest the user. In this way, the information processing apparatus 10 preferably prompts the user to permit the use of personal information. The information processing apparatus 10 also appropriately protects the privacy of the user when the user does not permit the use of personal information. The information processing apparatus 10 also handles the personal information of the user regarding the above-described estimation internally within the information processing apparatus 10 until the user permits the use of the personal information. In other words, the information processing apparatus 10 does not release the information on the network until the user has permitted the use of personal information. Therefore, the information processing apparatus 10 can appropriately protect the privacy of the user.

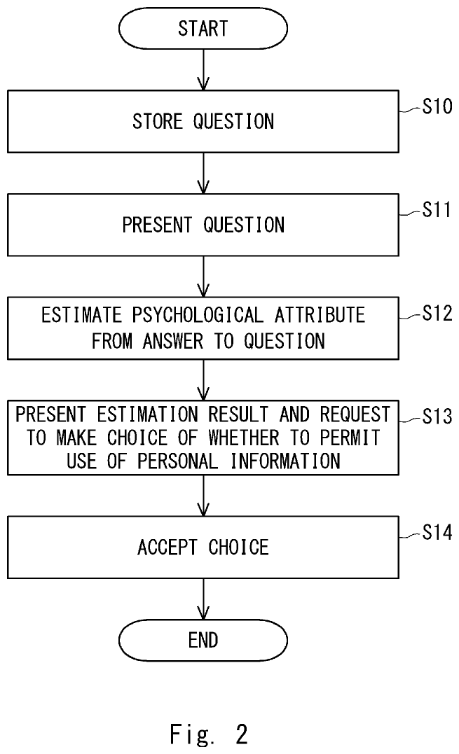

Next, processes executed by the information processing apparatus 10 are described. FIG. 2 is a flowchart of the information processing method according to the first example embodiment.

First, the storage unit 190 stores a question associated with the consumption behavior of a user (step S10). It is preferable that the process of the storage unit 190 storing the question has been performed in advance before the processes described hereinafter are performed.

Next, the question processing unit 110 presents the question and acquires an answer to the presented question (step S11). In other words, the question processing unit 110 reads a question from the question data stored in the storage unit 190 and presents the read question to the user. When the question processing unit 110 acquires an answer to the presented question, the acquired answer is supplied to the estimation unit 120.

Next, the estimation unit 120 receives the answer from the question processing unit 110 and estimates a user attribute from the received answer (step S12). The estimation unit 120 supplies information about a psychological attribute to the selection request unit 130 as a result of the estimation.

Next, the selection request unit 130 requests the user to make a choice as to whether to permit the use of personal information, along with presenting the result of the estimation received from the estimation unit 120 (step S13).

Next, the reception unit 140 accepts the choice made by the user (step S14). Upon accepting the choice, the information processing apparatus 10 ends the series of processes. Note that the information processing method described above may be stored in a computer-readable medium for causing a computer to execute the above-described method.

The first example embodiment has been described thus far. Note that the information processing apparatus 10 may be a terminal used by a user, provided that the function described above can be achieved. For example, the mode of the information processing apparatus 10 may be a television, a speaker, a watch, glasses, a pet robot, or the like. The information processing apparatus 10 may display the presentation of the question and the request for permission for the use of personal information as predetermined image information that can be viewed by the user. Alternatively, the information processing apparatus 10 may output the presentation or the request for permission for the use of personal information as predetermined audio information that can be recognized by the user. In addition, the information processing apparatus 10 may accept an answer to the question and whether to permit the use of personal information through an input device such as a button, or may accept them by various methods such as a touch panel, audio input, and gesture detection.

The information processing apparatus 10 has a processor and a storage device as components not illustrated. The storage device equipped in the information processing apparatus 10 includes a storage device including a non-volatile memory, such as a flash memory or a solid state drive (SSD). In this case, the storage device stores a computer program (hereinafter also simply referred to as a program) for performing the above-described method. The processor also loads a computer program from the storage device into a buffer memory such as a dynamic random access memory (DRAM) and executes the program. The storage device may be the same as the storage unit 190 described above.

Each component of the information processing apparatus 10 may be achieved by dedicated hardware. In addition, some or all of the components may be achieved by a general-purpose or dedicated circuitry, processor, or the like, or a combination thereof. These components may be constituted by a single chip or may be constituted by multiple chips connected via a bus. Some or all of the components of each apparatus may be achieved by a combination of the above-described circuitry and the like and a program. The processor may be a central processing unit (CPU), a graphics processing unit (GPU), a field-programmable gate array (FPGA), or the like. Note that the description of the components described herein may also be applied to other devices or systems described below in the present disclosure.

According to the present example embodiment, an information processing apparatus and the like can be provided for effectively acquiring opt-in while appropriately protecting the privacy of the user.

### Second Example Embodiment

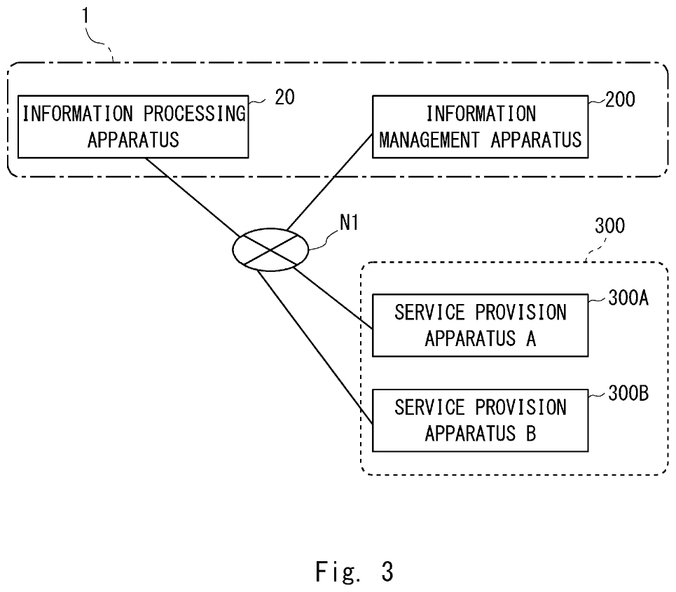

The second example embodiment is described next. FIG. 3 is a schematic configuration diagram of an information processing system 1 according to the second example embodiment. The information processing system 1 includes, as main components, an information processing apparatus 20 and an information management apparatus 200. The information processing apparatus 20 and the information management apparatus 200 are communicatively connected to each other via a network N1.

The information processing apparatus 20 is a mobile terminal used by a user. The information processing apparatus 20 asks the user a predetermined question and estimates a psychological attribute of the user based on the answer to the question. At this time, the information processing apparatus 20 executes the processing in a manner that does not externally release personal information such as the result of the answer. Furthermore, the information processing apparatus 20 presents the result of the estimation to the user and requests the user to make a choice as to whether to permit the use of personal information. When the user's choice that is received following this request is permission, the information processing apparatus 20 notifies the information management apparatus 200, via the network N1, of the acquired permission.

After receiving notification of the acquired permission from the information processing apparatus 20, the information management apparatus 200 selects an advertisement to be supplied to the information processing apparatus 20. At this time, the information management apparatus 200 selects an advertisement using the personal information associated with the information processing apparatus 20 and advertisement data pertaining to a plurality of advertisements. In addition, when selecting an advertisement, the information management apparatus 200 may acquire the personal information of the user from the service provision apparatus 300 within the scope included in the terms of the user's permission. The information management apparatus 200 then supplies the selected advertisement to the information processing apparatus 20 via the network N1.

The information processing system 1 is also communicatively connected to the service provision apparatus 300 via the network N1. The service provision apparatus 300 is managed by a business operator that carries out an arbitrary business for a user via the information processing apparatus 20. In the case in which there are a plurality of business operators, the service provision apparatus 300 may exist for each business operator. In the example illustrated in FIG. 3, the service provision apparatus 300 includes a service provision apparatus 300A managed by a business operator A and a service provision apparatus 300B managed by a business operator B.

The service provision apparatus 300 acquires the personal information of a user through a business carried out for the user. The personal information of the user in this case includes a population statistical attribute (also referred to as a demographic attribute) of the user. In other words, the demographic attribute is demographic data such as the age, gender, and place of residence of the user. The personal information held by the service provision apparatus 300 may also include the history of services used or products purchased by the user. The personal information held by the service provision apparatus 300 may also include a psychological attribute of the user.

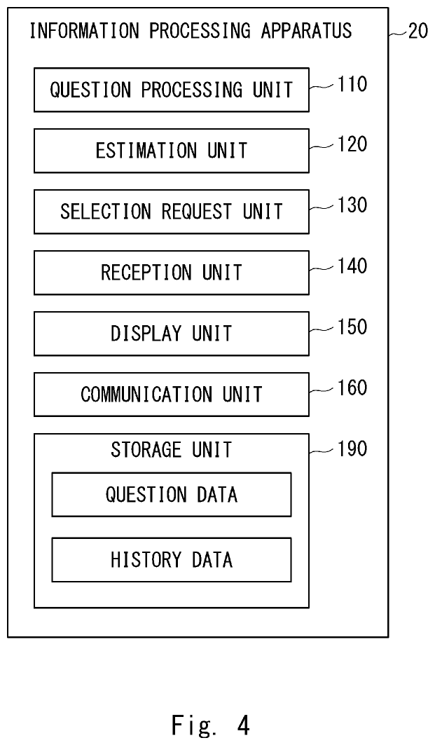

Next, the information processing apparatus 20 is described further with reference to FIG. 4. FIG. 4 is a block diagram of the information processing apparatus 20 according to the second example embodiment. The information processing apparatus 20 differs from the information processing apparatus 10 illustrated in FIG. 1 in that it has a display unit 150 and a communication unit 160. Each component of the information processing apparatus 20 has a function described later.

When the choice accepted by the reception unit 140 is not to permit the use of personal information, the question processing unit 110 according to the present example embodiment suppresses presenting the question until a predetermined condition is satisfied and resumes presenting the question after the predetermined condition is satisfied. For example, it is undesirable to immediately prompt a user who has just rejected permission for the use of personal information to make a choice of permission. Such a request lowers the user's mood.

Thus, the question processing unit 110 suppresses presenting a question for acquiring permission, for example, for a preset period of time (for example, one month, 100 days, or one year). Alternatively, the question processing unit 110 may measure the time that the user actually used the information processing apparatus 20 and may be set to resume the question according to the measured utilization time. Alternatively, the question processing unit 110 may be set to resume the question when the user chooses to view a predetermined advertisement. With such a configuration, even when opt-in has not been successfully acquired, the information processing apparatus 20 can appeal opt-in to the user again at suitable timing.

The question processing unit 110 according to the present example embodiment may determine the content of the question to be presented based on the history of answers received in the past. In this case, for example, the question processing unit 110 has a predetermined factor for estimating a psychological attribute. The predetermined factor is, for example, an item such as a lifestyle, a hobby, a preference, and a value. The question processing unit 110 stores the answer to the question in association with the respective factor. Then, when asking a new question, the question processing unit 110 selects and presents a question related to the factor that is necessary to estimate a psychological attribute using the answers acquired previously. With such a configuration, the information processing apparatus can efficiently present the result of the estimation.

The estimation unit 120 according to the present example embodiment determines, based on the result of the estimation, whether to continue presenting a question for updating the result of the estimation. In other words, when estimating a psychological attribute, the estimation unit 120 calculates a score indicating the certainty of the estimated psychological attribute, and determines not to continue presenting the question if the calculated score exceeds a predetermined threshold. On the other hand, when the calculated score does not exceed a predetermined threshold, the estimation unit 120 determines to continue presenting the question. The score indicating the certainty of the estimated psychological attribute is set, for example, for each factor associated with the answer. The threshold is set, for example, in such a way that the presentation of the question does not continue when the score of a predetermined number of factors exceeds a predetermined threshold. With such a configuration, the information processing apparatus 20 can improve the accuracy of the result of the estimation.

The display unit 150 is a display device including a liquid crystal panel, an organic electroluminescence, or the like, and displays various information to a user. The display unit 150, for example, displays a question to the user or displays the result of the estimation. The display unit 150 also displays a message requesting for a choice regarding the use of personal information.

The communication unit 160 includes an interface for connecting to the network N1. The communication unit 160 also has a function for determining whether to externally output information in accordance with the result of the choice accepted by the reception unit 140. More specifically, the communication unit 160 suppresses externally outputting the result of the choice when the result of the choice accepted by the reception unit 140 is not to permit the use of personal information. On the other hand, when the result of the choice accepted by the reception unit 140 is to permit the use of personal information, the communication unit 160 outputs the result of the choice to the information management apparatus 200. When the communication unit 160 outputs the result of the choice to the information management apparatus 200, the communication unit 160 acquires advertisement data associated with the personal information from the information management apparatus 200. With such a configuration, the information processing apparatus 20 can appropriately protect and utilize personal information.

The communication unit 160 according to the present example embodiment may also output the result of the estimation to the information management apparatus 200 when the result of the choice is to permit the use of personal information. In other words, the communication unit 160 may provide the psychological attribute of a user included in the history information to the information management apparatus 200 when the result of the choice is to permit the use of personal information. In this way, the information processing system 1 can appropriately utilize the permitted personal information to provide the user with information of higher interest for the user.

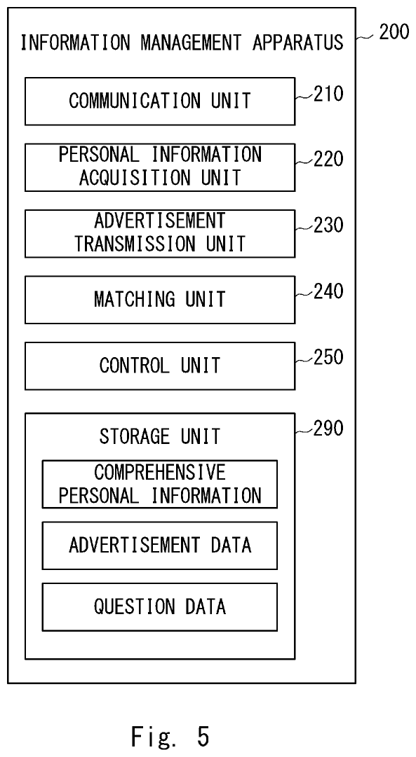

Next, the information management apparatus 200 is described further with reference to FIG. 5. FIG. 5 is a block diagram of the information management apparatus 200 according to the second example embodiment. The information management apparatus 200 includes, as main components, a communication unit 210, a personal information acquisition unit 220, an advertisement transmission unit 230, a matching unit 240, a control unit 250, and a storage unit 290.

The communication unit 210 includes an interface for the information management apparatus 200 to connect to the network N1. The communication unit 210 receives, via the network N1, information from the information processing apparatus 20 regarding permission for the use of personal information. The communication unit 210 also receives advertisement data from the advertisement transmission unit 230 and supplies the received advertisement data to the information processing apparatus 20. The communication unit 210 also communicatively connects to the service provision apparatus 300 and receives personal information held by the service provision apparatus 300 within the scope of the permission of the user. Furthermore, when the question data stored in the storage unit 290 is updated, the communication unit 210 supplies the updated question data to the information processing apparatus 20.

The personal information acquisition unit 220 acquires personal information from the service provision apparatus 300 via the communication unit 210. The personal information acquisition unit 220 also acquires a psychological attribute pertaining to the result of the estimation from the information processing apparatus 20. The personal information acquisition unit 220 causes the storage unit 290 to store the acquired information as comprehensive personal information.

The advertisement transmission unit 230 reads the advertisement data pertaining to the advertisement selected by the matching unit 240 from the storage unit 290 and supplies the read advertisement data to the information processing apparatus 20 via the communication unit 210.

The matching unit 240 selects an advertisement to be supplied to the information processing apparatus 20 using the result of the estimation received from the information processing apparatus 20, the personal information associated with the information processing apparatus 20, and the advertisement data pertaining to a plurality of advertisements. In other words, the matching unit 240 matches the psychological and demographic attributes of the user with the advertisement data to select an advertisement to provide to the user. The matching unit 240 supplies information about the selected advertisement to the advertisement transmission unit 230.

The control unit 250 includes a computation device such as a CPU and appropriately controls the processing of each component held by the information management apparatus 200. For example, if the control unit 250 is instructed by an administrator who manages the information management apparatus 200 to update the question data stored in the storage unit 290, the control unit 250 updates the question data as necessary and further supplies the updated question data or the updated information of the question data to the information processing apparatus 20 via the communication unit 210. Thus, the information processing system 1 can present a question that is more likely to interest the user. Note that the control unit 250 may include some or all of the functions provided by the communication unit 210, the personal information acquisition unit 220, the advertisement transmission unit 230, and the matching unit 240.

The storage unit 290 is a storage device including a non-volatile memory. The storage unit 290 stores comprehensive personal information, advertisement data, and question data. The comprehensive personal information is information associated with a user, and includes a psychological attribute acquired from the information processing apparatus 20 and personal information acquired from the service provision apparatus 300. The advertisement data are advertisement data to be supplied to the information processing apparatus 20. The advertisement data include the content of an advertisement and collateral information of the advertisement. The collateral information of the advertisement is information used by the matching unit 240 for making an association with personal information. The collateral information of the advertisement is, for example, related to the genre of a copyrighted work, a lifestyle, an activity, and the like. The question data may be the same as the question data stored in the information processing apparatus 20. The question data may also be set to include the content of a question to be supplied to each user.

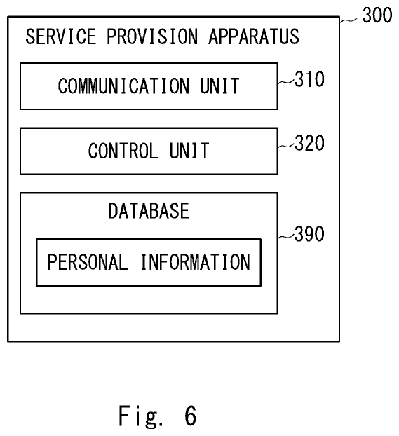

Next, the service provision apparatus 300 is described with reference to FIG. 6. FIG. 6 is a block diagram of the service provision apparatus 300 according to the second example embodiment. The service provision apparatus 300 is a computer, a server, a part of a cloud, or the like that is managed by each business operator. The service provision apparatus 300 includes, as main components, a communication unit 310, a control unit 320, and a database 390.

The communication unit 310 includes an interface for the service provision apparatus 300 to connect to the network N1. The communication unit 310 performs data communication with the information processing apparatus 20 within the scope of the authority of each user and business operator. At this time, the service provision apparatus 300 acquires personal information from the information processing apparatus 20, for example, in order to provide a predetermined service to the information processing apparatus 20. Upon acquiring personal information from the information processing apparatus 20, the service provision apparatus 300 stores the personal information in the database 390. The communication unit 310 also provides personal information to the information management apparatus 200 in response to a request from the information management apparatus 200.

The control unit 320 includes a computation device for controlling each component of the service provision apparatus 300. The database 390 is a storage device including a non-volatile memory and stores personal information acquired from the information processing apparatus 20.

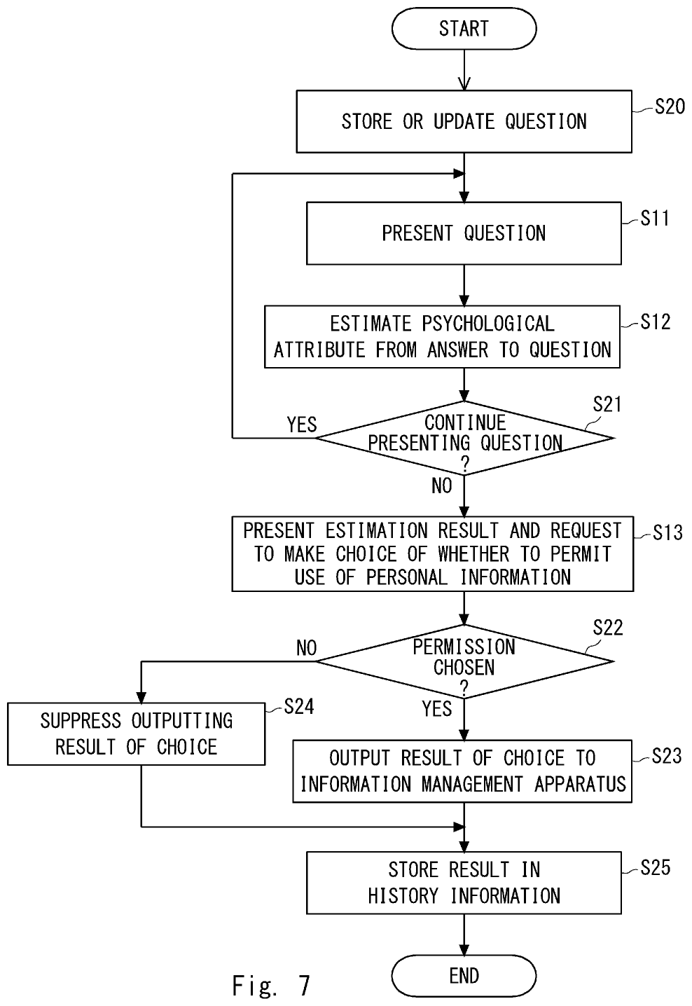

Next, processes executed by the information processing apparatus 20 of the information processing system 1 are described with reference to FIG. 7. FIG. 7 is a flowchart of the information processing method according to the second example embodiment. Of the processes illustrated in the flowchart of FIG. 7, the processes that are equivalent to the processing illustrated in FIG. 2 are denoted by signs as illustrated in FIG. 2. Specifically, steps S11, S12, and S13 are equivalent to the processes illustrated in FIG. 2. Therefore, the details of these processes are omitted here.

First, the information processing apparatus 20 performs the process of storing question data or updating the question data stored in advance (step S20). Note that this process is omitted when the question data have already been stored and there is no need to update the question data.

Next, the question processing unit 110 presents a question (step S11). In this case, specifically, the display unit 150 of the information processing apparatus 20 displays the question. Next, the estimation unit 120 estimates a psychological attribute based on the acquired answer (step S12).

Next, the estimation unit 120 determines whether to continue presenting the question (step S21). When it is determined to continue presenting the question (step S21: YES), the information processing apparatus 20 returns to step S11 and presents the question. At this time, the question processing unit 110 refers to the historical information and presents a question that is different from the one for which the answer has already been acquired. On the other hand, when it is determined not to continue presenting the question (step S21: NO), the information processing apparatus 20 proceeds to step S13. At step S13, the selection request unit 130 displays the result of the estimation and requests for making a choice as to whether to permit the use of personal information (step S13).

Next, the information processing apparatus 20 determines whether the choice accepted by the reception unit 140 is to select permission (step S22). When it is determined that the accepted choice is to select permission (step S22: Yes), the information processing apparatus 20 proceeds to step S23. On the other hand, if it is not determined that the accepted choice is to select permission (step S22: NO), the information processing apparatus 20 proceeds to step S24.

At step S23, the communication unit 160 receives information that the user's choice indicates permission for the use of personal information and outputs this received information to the information management apparatus 200 (step S23). After outputting the permission information to the information management apparatus 200, the information processing apparatus 20 proceeds to step S25.

At step S24, the communication unit 160 suppresses externally outputting the result of the choice (step S24) and proceeds to step S25.

At step S25, the information processing apparatus 20 stores the result of the choice in the history information of the storage unit 190 (step S25). Note that, at this time, whether the result of the choice may indicate permission or disapproval, the result of the choice is stored in the historical information. When the result of the choice is stored in the history information, the information processing apparatus 20 ends the series of processes.

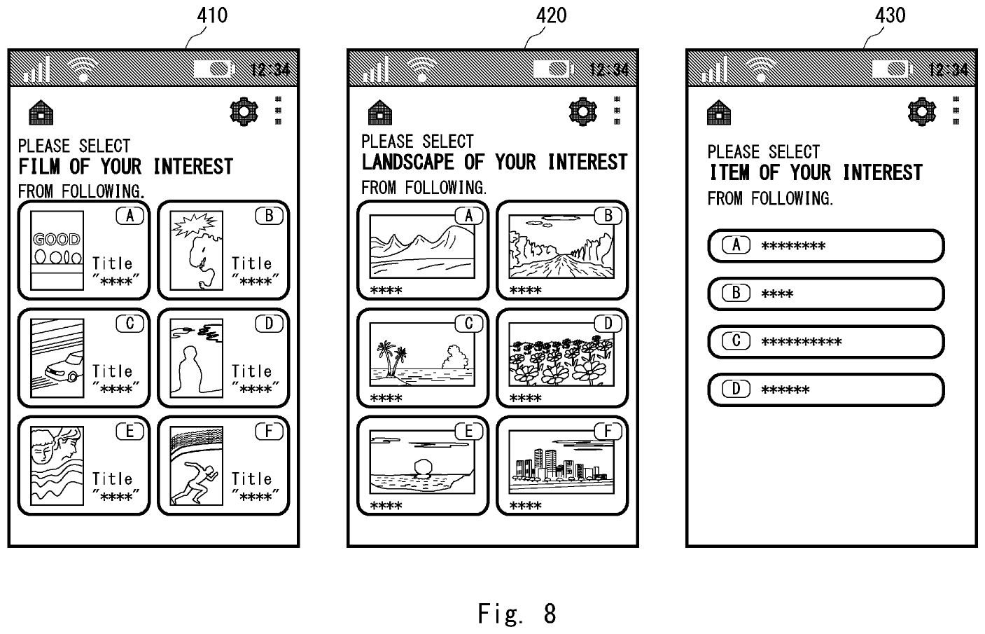

Next, an example of a question that the information processing apparatus displays on the display unit 150 is described with reference to FIG. 8. FIG. 8 is a diagram illustrating an example of a question presented to the information processing apparatus. FIG. 8 illustrates a first screen 410, a second screen 420, and a third screen 430.

The first screen 410 displays six different films from “A” to “F” along with a message “Please select a film of your interest from the following.” The display unit 150 is superimposed with a touch panel, and a display indicating six films “A” to “F” can be selected by the touch panel. When a user selects any one of “A” to “F,” the first screen 410 ends and the display unit 150 moves to the next screen.

The second screen 420 displays six different landscape photos from “A” to “F” along with a message “Please select a landscape of your interest from the following.” When the user selects any one of “A” to “F,” the second screen 420 ends and the display unit 150 moves to the next screen.

The third screen 430 displays descriptions of four different items from “A” to “D” along with a message “Please select an item of your interest from the following.” When the user selects any one of “A” to “D,” the third screen 430 ends and the display unit 150 moves to the next screen.

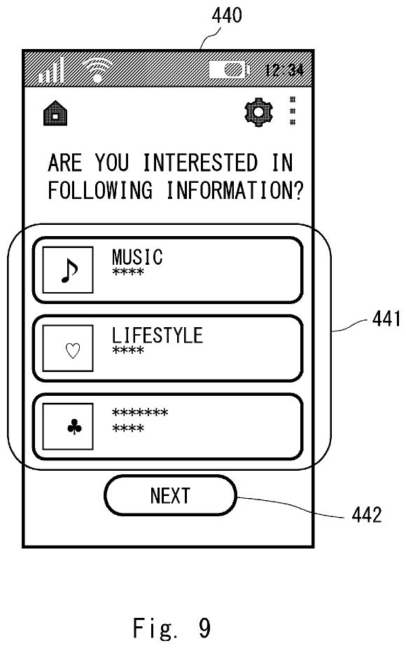

Next, an example of the result of the estimation that the selection request unit 130 causes the display unit 150 to display is described with reference to FIG. 9. FIG. 9 is a diagram illustrating an example of the result of estimation presented on the information processing apparatus. FIG. 9 illustrates a fourth screen 440. The fourth screen 440 displays an estimation result display 441 indicating predetermined properties about “music,” “lifestyle,” and other domains of interest along with a message “Are you interested in the following information?”

Here, the display about the “music” domain is associated with the result of the estimation acquired from the user's answer to a question, in which music genres such as “rock,” “classical,” and “jazz,” as well as specific artist names are displayed. The display about the “lifestyle” domain is associated with the result of the estimation acquired from the user's answer to a question, in which “yoga,” “travel,” “spending time with family” and the like are displayed. Similarly, for other domains, information associated with the result of the estimation acquired from the user's answer to a question is indicated.

The fourth screen 440 also indicates a button 442 that is labeled “Next” below the estimation result display 441. When the user taps this button 442, the information processing apparatus 20 transfers the contents of the display unit 150 to the next screen.

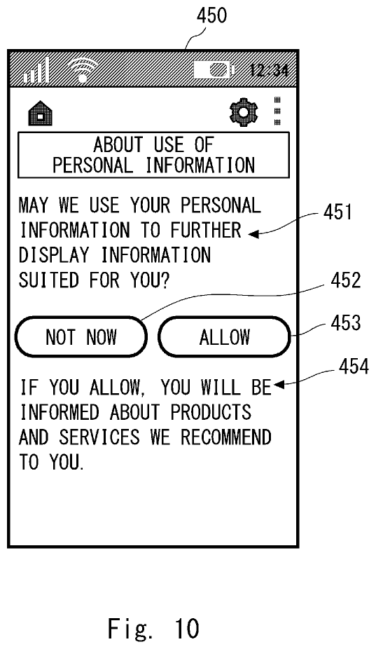

Next, the selection request screen is explained with reference to FIG. 10. FIG. 10 is a diagram illustrating an example of choices presented on the information processing apparatus 20. FIG. 10 illustrates a fifth screen 450. The fifth screen 450 displays a first request message 451, a first button 452, a second button 453, and a second request message 454 along with a message “About the use of personal information.”

The first request message 451 is a message requesting for making a choice of the use of personal information. In the case of FIG. 10, the first request message reads “May we use your personal information to further display information that is suited for you?”

The first button 452 is a button labeled “Not now” that is a button to be tapped when the user does not permit the use of personal information. The second button 453 is a button labeled as “Allow” that is a button to be tapped when the user permits the use of personal information.

The second request message 454 reads “If you allow, you will be informed about products and services we recommend to you.”

Display examples of the information processing apparatus 20 have been described thus far. According to the present example embodiments, a question is asked and an answer is received, for example, in an application program of a mobile terminal. The information processing apparatus 20 then displays a domain that is likely to interest a user on the display unit 150. In this way, the information processing apparatus 20 preferably prompts the user to permit the use of personal information.

In addition, the information processing apparatus 20 does not externally disclose personal information before acquiring permission. After acquiring permission, the information management apparatus 200 can provide information of high interest to the user. In this way, an information processing apparatus and an information processing system can be provided for effectively acquiring opt-in while appropriately protecting the privacy of a user.

### <Example of Hardware Configuration>

The following describes a case in which the functional components of the information processing apparatus according to the present disclosure are achieved in a combination of hardware and software.

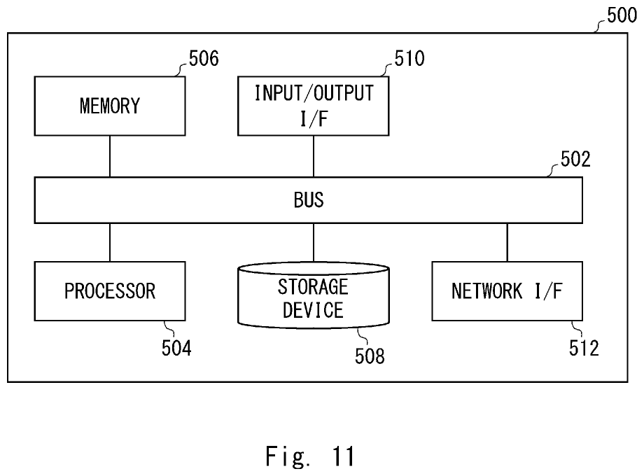

FIG. 11 is a block diagram exemplifying the hardware configuration of a computer. The information processing apparatus according to the present disclosure can achieve the aforementioned functions by a computer 500 that includes hardware components illustrated in FIG. 11. The computer 500 may be a portable computer such as a smartphone or a tablet terminal, or may be a stationary computer such as a PC. The computer 500 may be a dedicated computer designed to achieve each apparatus or may be a general-purpose computer. The computer 500 can achieve a desired function by installing a predetermined program.

The computer 500 has a bus 502, a processor 504, a memory 506, a storage device 508, an input/output interface 510 (the interface is also abbreviated as I/F), and a network interface 512. The bus 502 is a data transmission path for the processor 504, the memory 506, the storage device 508, the input/output interface 510, and the network interface 512 to send and receive data to and from each other. However, the method of connecting the processor 504 and the like to each other is not limited to the bus connection.

The processor 504 is any of a variety of processors, such as a CPU, a GPU and an FPGA. The memory 506 is a main storage device that is achieved using a random access memory (RAM) or the like.

The storage device 508 is an auxiliary storage device that is achieved using a hard disk, an SSD, a memory card, a read only memory (ROM) or the like. The storage device 508 stores a program for achieving desired functionality. The processor 504 loads and executes this program in the memory 506 to achieve the functional components of each apparatus.

The input/output interface 510 is an interface in order to connect the computer 500 to the input/output device. For example, the input/output interface 510 is connected to an input device such as a keyboard, an output device such as a display device, and the like.

The network interface 512 is an interface for connecting the computer 500 to a network.

Although an example of the hardware components according to the present disclosure has been described, the above-described example embodiments are not limited to this example. The present disclosure can also achieve arbitrary processing by causing a processor to execute a computer program.

In the above example, the program includes a set of instructions (or software codes) that, when read into a computer, causes the computer to perform one or more functions described in the example embodiments. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

According to the present disclosure, an information processing apparatus and the like can be provided for effectively acquiring opt-in while appropriately protecting the privacy of the user.

The first and second embodiments can be combined as desirable by one of ordinary skill in the art.

What is claimed is:

1. An information processing apparatus comprising:
a storage unit configured to store a question being at least associated with a consumption behavior of a user; and
at least one processor,
wherein the processor performs the following processing:
presenting the question and acquiring an answer to the presented question;
estimating a psychological attribute of the user, based on the answer;
requesting the user to make a choice as to whether to permit use of personal information, along with presenting a result of the estimation; and
accepting a result of the choice.

2. The information processing apparatus according to claim 1, wherein the at least one processor further performs the following processing:
when the accepted choice is not to permit use of personal information, suppressing presentation of the question until a predetermined condition is satisfied, and resuming presentation of the question after the predetermined condition is satisfied.

3. The information processing apparatus according to claim 1, wherein the at least one processor further performs the following processing:
determining a content of the question to be presented based on an answer history regarding the answer received in past.

4. The information processing apparatus according to claim 1, wherein the at least one processor further performs the following processing:
determining, based on the result of the estimation, whether to continue presentation of the question for updating the result of the estimation.

5. The information processing apparatus according to claim 1, wherein
the at least one processor further performs the following processing:
when the result of the choice is not to permit use of the personal information, suppressing externally outputting the result of the choice; and,
when the result of the choice is to permit use of the personal information, outputting the result of the choice to an information management apparatus and acquiring advertisement data associated with the personal information from the information management apparatus.

6. The information processing apparatus according to claim 5, wherein the at least one processor further performs the following processing:
when the result of the choice is to permit use of the personal information, outputting the result of the estimation to the information management apparatus.

7. An information processing system comprising:
the information processing apparatus according to claim 6; and
the information management apparatus configured to use a result of the estimation received from the information processing apparatus, the personal information associated with the information processing apparatus, and advertisement data pertaining to a plurality of advertisements and select at least one of the advertisements to be supplied to the information processing apparatus.

8. The information processing system according to claim 7, wherein the information management apparatus supplies updated information of the question to the information processing apparatus.

9. An information processing method including, by a computer:
storing a question associated with a consumption behavior of a user;
presenting the question and acquiring an answer to the presented question;
estimating a user attribute, based on the answer to the question;
requesting the user to make a choice as to whether to permit use of personal information, along with presenting a result of the estimation; and
accepting a result of the choice.

10. A non-transitory computer-readable medium storing a program causing a computer to execute an information processing method including:
storing a question associated with a consumption behavior of a user;
presenting the question and acquiring an answer to the presented question;
estimating a user attribute, based on the answer to the question;
requesting the user to make a choice as to whether to permit use of personal information, along with presenting a result of the estimation; and
accepting a result of the choice.
